(19) United States
(12) Patent Application Publication
(10) Pub. No.: US 2015/0201443 A1
(43) Pub. Date: Jul. 16, 2015

(54) POINT AND SHARE USING IR TRIGGERED P2P

(71) Applicant: QUALCOMM Incorporated, San Diego, CA (US)

(72) Inventors: Krishna Chaitanya Suryavenkata Emani, Hyderabad (IN); Chinamay Kumar, Hyderabad (IN); Anil Kumar Daga, Hyderabad (IN)

(73) Assignee: QUALCOMM Incorporated, San Diego, CA (US)

(21) Appl. No.: 14/152,717

(22) Filed: Jan. 10, 2014

(51) Int. Cl. H04W 76/02; H04B 10/114

(52) U.S. Cl. CPC H04W 76/023; H04B 10/1143; H04W 84/12

(57) ABSTRACT

Methods, systems, and devices are described for establishing an infrared (IR) triggered radio communication connection between two devices. Upon aligning IR ports, IR trigger messages can be exchanged between devices and/or access points using an IR communication link, where the IR trigger messages indicate intent and capability of establishing the connection. The IR trigger messages may trigger device discovery and connection using the radio communication technology. Additional operations (e.g., exchanging files, streaming content, etc.) may be performed automatically between the devices upon establishing the connection. The radio communication technology may include wireless local area network (WLAN), Wi-Fi, Wi-Fi P2P, Wi-Fi-Direct, or other similar radio link between two devices, such as between a mobile device and another mobile device, a printer, a display, an Access Point, and the like.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include an access point (AP) and at least one client device. The access point may be coupled to a network, such as the Internet, and enable the client device to communicate via the network (and/or communicate with other devices coupled to the access point).

Particular implementations of Wi-Fi may enable devices to connect easily with each other at Wi-Fi data transfer rates without requiring a dedicated Wi-Fi access point (hard AP). Communication links using these techniques may be known as peer-to-peer (P2P) links. Examples of P2P technologies include Wi-Fi P2P and Wi-Fi Direct. For example, a Wi-Fi-Direct enabled device can be elected to operate as a soft-AP or Group Owner (GO) for communications with other Wi-Fi devices. Wi-Fi Direct enables the formation of a P2P group directly between two devices, resulting in reduced network setup time and procedures, increased network flexibility, etc. With the use of P2P technologies including Wi-Fi Direct, file sharing between wireless capable devices, such as between mobile devices or between a mobile device and other wireless capable devices such as displays, printers, and other devices has become even faster. However, even with reduced setup time of a Wi-Fi P2P or Wi-Fi Direct connection, delays still exist in network initialization.

In current implementations forming WLAN connections may involve several manual steps performed by the user. For example, when a user of a mobile device connects to a WLAN, the user selects the network for connection and in some cases manually enters security information to establish the WLAN connection. Manually selecting the network and entering security information may introduce unwanted delays in the WLAN connection procedure. Similarly, to access a P2P connection, such as Wi-Fi Direct, a user accesses the Wi-Fi Direct P2P interface and launches a search for a peer device. Once the peer device is found, the user initiates a connection with the peer device and subsequently forms a P2P group between the devices to share files/services between them. The time needed to establish a P2P connection may be delayed due to a cumbersome user interface of the initiating peer device and/or the receiving peer device (e.g., a mobile device, television, printer, projector, etc.), time spent searching for the peer device, and difficulty in establishing a connection with a peer device because of connection problems or delays, etc. These delays can significantly impact the user experience when setting up a WLAN connection and/or when transferring files or other data between devices using various WLAN technologies.

### SUMMARY

Methods, systems, and devices are provided that utilize an infrared (IR) link to trigger and setup a radio communication link between two devices. In one example, an IR port on a device, such as a mobile device, can be directed towards the IR port of another device, such as another mobile device, an access point (AP), a display (e.g., projector, photo frame, computer monitor, TV, etc.), printer, or other device to set up a radio communication link between the devices. In some implementations, the radio communication link may utilize a technology for a Wireless Local Area Network (WLAN). An application, protocol, program, or other set of instructions on a first device, such as a mobile device, can be implemented to send an IR trigger and automatically setup a WLAN connection with a second device. The devices may then share files or other information, establish other connections (e.g., Internet service, etc.), join a group, etc., using the WLAN connection. In another example, for instance when one device does not have IR capability, an add-on device may be connected to the device to allow the device to communicate via IR. The add-on device can enable the device to transmit and receive IR trigger signals to establish radio communication links, such as WLAN links, with other devices.

In some embodiments, a method for establishing an IR triggered WLAN link includes transmitting a first IR trigger message indicating an intent to establish a connection using a radio communication technology from a first device to a second device using an IR communication link. The method may further include receiving, via the IR communication link, a second IR trigger message and establishing the connection with the second device using the radio communication technology. In some embodiments, the radio communication technology may include one of Wi-Fi P2P or Wi-Fi-Direct, and the connection may be a peer-to-peer (P2P) connection. In some cases, the first device or the second device may be a mobile device, a printer, a projector, an display, a photo frame, or a set-top box. The other of the first device or second device may be a mobile device.

In some embodiments, a method for establishing an IR triggered WLAN connection may also include determining that an IR signal strength of the IR communication link is above a threshold signal strength based on the received second IR trigger message and determining that the second IR trigger message indicates an intent and a capability to establish the connection using the radio communication technology.

In some embodiments, establishing the connection may include transmitting, by the first device, a scan request using the radio communication technology and receiving, by the first device, a scan response from the second device using the radio communication technology. Establishing the connect may additionally or alternatively include determining a P2P initiator device by comparing a MAC address of the first device and a MAC address of the second device and transmitting, by the first device if it is the determined P2P initiator device, a provisional discovery (PD) request to initialize a P2P group with the second device. In some cases, establishing the connection may also include exchanging the MAC addresses of the first and second devices for determining the P2P initiator device via the IR communication link.

In some embodiments, establishing the connection with the second device may include exchanging connection information associated with the radio communication technology with the second device over the IR communication link. The connection information may include one or more of a P2P IE intent value, a listening channel ID, or an operating channel ID. Establishing the connection may include transmitting connection information to a third device to allow the third device to establish the connection with the second device using the radio communication technology.

In other embodiments, a computer program product may include a non-transitory computer-readable medium storing instructions that are executable by a processor to transmit a first infrared (IR) trigger message indicating an intent to establish a connection using a radio communication technology to a second device using an IR communication link. In addition, the instructions may be executable by the processor to receive, via the IR communication link, a second IR trigger message and establish the connection with the second device using the radio communication technology.

In some embodiments, the instructions may be executable by the processor to determine that an IR signal strength of the IR communication link is above a threshold signal strength based on the received second IR trigger message and determine that the second IR trigger message indicates an intent and a capability to establish the connection using the radio communication technology.

In some embodiments, the instructions executable by the processor to establish the connection may further include instructions to transmit a scan request using the radio communication technology and receive a scan response from the second device using the radio communication technology. In additional or alternative embodiments, the instructions executable by the processor to establish the connection may include instructions to determine a P2P initiator device by comparing a MAC address of the wireless communications device and a MAC address of the second device and transmit, if the wireless communications device is the P2P initiator device, a provisional discovery (PD) request to initialize a P2P group with the second device.

In other embodiments, a wireless communications device may include an infrared (IR) communication port configured to transmit a first infrared (IR) trigger message to a second device over an IR communication link, with the first IR trigger message indicating an intent to establish a connection using a radio interface of the wireless communications device. The IR communication port may also be configured to receive, via the IR communication link, a second IR trigger message. A radio interface, which may be communicably coupled to the IR communication port, may be configured to, in response to the IR communication port receiving the second IR trigger message, establish the connection with the second device.

In some embodiments, the IR communication port may further determine that an IR signal strength of the IR communication link is above a threshold signal strength based on the received second IR trigger message, and determine that the second IR trigger message indicates the intent and a capability to establish the connection using the radio communication technology.

In some embodiments, the radio interface may transmit a scan request using the radio communication technology and receive a scan response from the second device using the radio communication technology.

In some embodiments, the IR communication port may transmit and receive connection information to and from the second device over the IR communication link. The connection information may include one or more of a P2P IE intent value, a listening channel ID, or an operating channel ID. The IR communication port may transmit connection information to a third device to allow the third device to establish the connection with the second device using the radio communication technology.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a system for implementing an IR triggered WLAN connection in accordance with various embodiments;

FIG. 2 shows another diagram of a system for implementing an IR triggered WLAN connection in accordance with various embodiments;

FIG. 3A shows a message flow diagram for utilizing an IR triggered WLAN connection in accordance with various embodiments;

FIG. 3B shows another message flow diagram for utilizing an IR triggered WLAN connection in accordance with various embodiments;

FIG. 4A shows a block diagram illustrating a device for utilizing an IR triggered WLAN connection in accordance with various embodiments;

FIG. 4B shows another block diagram illustrating a device for utilizing an IR triggered WLAN connection in accordance with various embodiments;

FIGS. 5 show another block diagram illustrating a device for utilizing an IR triggered WLAN connection in accordance with various embodiments;

FIG. 6 shows a block diagram of an add-on device for utilizing an IR triggered WLAN connection in accordance with various embodiments;

FIG. 7 shows another block diagram of an add-on device for utilizing an IR triggered WLAN connection in accordance with various embodiments;

FIG. 8 is a flowchart of a method of implementing an IR triggered WLAN connection in accordance with various embodiments;

FIG. 9 is a flowchart of another method of implementing an IR triggered WLAN connection in accordance with various embodiments; and

FIG. 10 is a flowchart of another method of implementing an IR triggered WLAN connection in accordance with various embodiments.

### DETAILED DESCRIPTION

Methods, systems, and devices are provided that utilize an infrared (IR) link to trigger and setup a radio communication link between two devices. In one example, an IR port on a device, such as a mobile device, can be directed towards the IR port of another device, such as another mobile device, an access point (AP), a display (e.g., projector, photo frame, computer monitor, TV, etc.), printer, or other device to set up a radio communication link between the devices. In some implementations, the radio communication link may utilize a technology for a Wireless Local Area Network (WLAN), such as Wi-Fi, Wi-Fi P2P, Wi-Fi Direct, and the like. An application, protocol, program, or other set of instructions on a first device, such as a mobile device, can be implemented to send an IR trigger and automatically setup a WLAN connection with a second device upon the receipt of an IR trigger or IR trigger response from the second device. The devices may then share files or other information, establish other connections (e.g., Internet service, etc.), join a group, etc., using the WLAN connection. In another example, for instance when one device does not have IR capability, an add-on device may be connected to the device via existing communications ports to allow the device to communicate via IR. The add-on device can enable the device to transmit and receive IR trigger signals to establish a radio communication link, such as a WLAN or Wi-Fi-Direct link, with another device.

The described methods, systems, and devices can provide an enhanced user experience by allowing a user to transfer files, share information, form an ad-hoc network, automatically connect to a WLAN network, etc., by simply pointing a mobile device at another device, such as an access point, a printer, a display, or even another mobile device, to automatically set up a WLAN connection. IR technology can provide communication over a distance of up to 10-15 meters, which can allow a user and another device, such as a peer device, at a far corner of a room to transfer files by pointing the devices at each other. This may provide a longer range and greater setup and sharing capabilities than current Near Field Communications (NFC). Through various applications or programs a user can transfer files between the devices in a simple, expedient manner. In some implementations, an application or program can allow a user to take an action to set up the WLAN link and transfer data between two devices. In some cases, the user may first align the IR ports of the two devices to allow an IR link to be established. The user may, concurrently or subsequently to aligning the IR ports, perform an action (e.g., opening an application, enabling a feature, selecting files to transfer and swiping the selected files toward a target device, etc.) to establish the WLAN link with the target device and/or perform other operations directed to the target device. In other embodiments, the user may perform the action indicating an intention to form an IR triggered WLAN connection with a target device prior to aligning the IR ports of the two devices. In this scenario, the IR triggered WLAN connection may be initiated when IR ports of the two devices are subsequently aligned.

The following description provides examples and is not limiting of the scope, applicability, or configuration set forth in the claims. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments. As referred to herein, a WLAN connection or link may be synonymous with a Wi-Fi, Wi-Fi Direct or Wi-Fi- P2P connection or group, Wi-Fi Display, Miracast, or other WLAN communication technologies. For the purposes of explanation, the described methods, systems, and devices refer specifically to WLAN; however, other radio communication or access technologies may be compatible with and implemented using the described techniques.

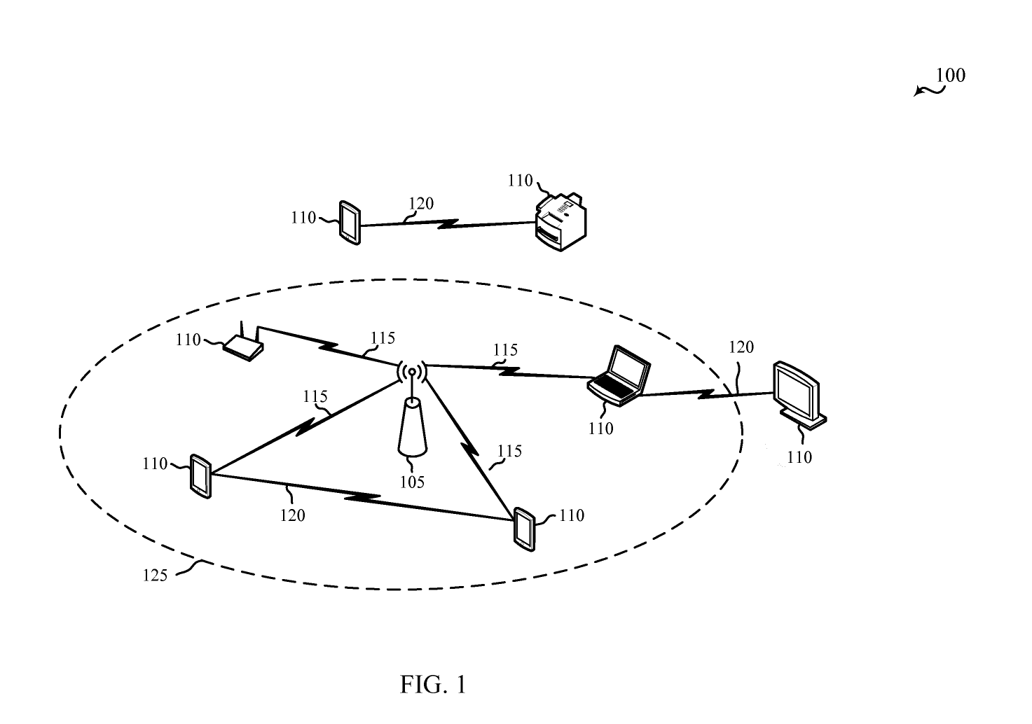

Referring first to FIG. 1, a block diagram illustrates an example of a WLAN or Wi-Fi network 100 such as, e.g., a network implementing at least one of the IEEE 802.11 family of standards. The network 100 may include an access point (AP) 105 and one or more wireless devices 110, such as mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the network 100 may have multiple APs 105. Each of the wireless devices 110, which may also be referred to as a wireless station, a station (STA), a mobile station (MS), a mobile device, an access terminal (AT), a user equipment (UE), a subscriber station (SS), or a subscriber unit, may associate and communicate with an AP 105 via a communication link 115. Each AP 105 has a coverage area 125 such that stations 110 within that area can typically communicate with the AP 105. The devices 110 may be dispersed throughout the coverage area 125. Each device 110 may be stationary or mobile.

Although not shown in FIG. 1, a station 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A coverage area 125 for an access point 105 may be divided into sectors making up only a portion of the coverage area (not shown). The system 100 may include access points 105 of different types (e.g., metropolitan area, home network, etc.), with varying sizes of coverage areas and overlapping coverage areas for different technologies. Although not shown, other wireless devices can communicate with the AP 105.

While the devices 110 may communicate with each other through the AP 105 using AP links 115, each device 110 may also communicate directly with one or more other devices 110 via a direct wireless link 120. Two or more devices 110 may communicate via a direct wireless link 120 when both devices 110 are in the AP coverage area 125, when one device 110 is within the AP coverage area 125, or when neither of the devices 110 is within the AP coverage area 125. Examples of direct wireless links 120 may include Wi-Fi Direct connections, connections established by using a Wi-Fi Tunneled Direct Link Setup (TDLS) link, and other P2P group connections. The Wi-Fi devices and APs 110, 105 in these examples may communicate according to the WLAN radio and baseband protocol including physical and MAC layers from IEEE 802.11, and its various versions including, but not limited to, 802.11b, 802.11g, 802.11a, 802.11n, 80211ac, 80211ad, 80211ah, etc. In other implementations, other peer-to-peer connections and/or ad hoc networks may be implemented in system 100.

In various embodiments, a device 110 may be connected to a another device 110 via a Wi-Fi Display connection 120. Wi-Fi Display, which may be known as Miracast, allows one device 110, such as a portable device or computer, to wirelessly transmit video and audio to a compatible display, such as another device 110. Wi-Fi Display enables delivery of compressed standard or high-definition video over a direct wireless link (e.g., peer-to-peer link 120), or an indirect wireless link (e.g., via AP link 115).

Miracast allows users to echo the display from a first device 110 onto the display of another device 110 by video and/or audio content streaming. In some implementations, the link 120 between the two devices 110 may be bi-directional. In one configuration, the connection between the two devices 110 may also allow users to launch applications stored on a first device 110 via a second device 110. For example, the second device 110 may include various input controls (e.g., mouse, keyboard, knobs, keys, user interface buttons). These controls may be used at the second device 110 to initialize and interact with applications stored on the first device 110.

Generally, the time taken to initiate a direct link 120 between two peer devices 110 may be delayed due to a cumbersome user interface of the initiating peer device 110 and/or the receiving peer device 110, time spent searching for a peer device 110, and difficulty in establishing a connection with a peer device 110 because of connection problems or delays, etc. These delays can significantly impact the user experience when transferring files or other data between devices 110 using the various WLAN technologies.

Similarly, the time taken to establish a WLAN connection via an AP link 115 between a mobile device 110, for example, and an access point 105, can be cumbersome and introduce delays to the user. These delays may be due to time spent accessing a Wi-Fi interface to select a network, such as network 100, to establish a connection, and in some cases entering security information (e.g., a password, etc.) to access the network 100. Furthermore, in some cases, even more delay may be introduced as accessing the network 100 may require the user to manually obtain the security information, such as from a salesperson at a coffee shop.

The components of system 100 such as the devices 110 and/or access points 105 may be configured to utilize an infrared (IR) link to trigger and setup a radio communication link between two devices. In one example, an IR port on a device 110, such as a mobile device, can be directed towards the IR port of another device 110 or access point 105 to trigger the radio communication link setup and possibly further user-defined operations between the devices. In some implementations, the radio communication link may utilize a WLAN technology such as Wi-Fi, Wi-Fi P2P, Wi-Fi Direct, etc. An application, protocol, program, or other set of instructions on a first device, such as a mobile device 110, can be implemented to send an IR trigger and automatically setup a WLAN connection with a second device upon the receipt of an IR trigger or IR trigger response from the second device (e.g., device 110 or AP 105, etc.). The devices may then share files or other information, establish other connections (e.g., Internet service, etc.), join a group, etc., using the WLAN connection.

In some instances, when one or more of the devices 110 or APs 105 is not IR communication enabled, an add-on device or module implementing IR communication technology may be connected to one or more communication ports of the device 110 or AP 105 to allow the device to establish and/or communicate via an IR link. In this way, any device with WLAN/Wi-Fi connectivity or that is WLAN/Wi-Fi enabled may implement aspects of this disclosure to more quickly form a radio communication link and, for example, share files, data, etc.

In some embodiments, devices 110 or APs 105 may be configured to perform one or more actions over the WLAN link automatically based on the IR trigger. For example, a user of a device 110 may demonstrate an intent to perform an IR triggered action directed to a target device 110, 105, e.g., by performing a user input that indicates a desire to connect to a WLAN network, form an ad-hoc network or P2P group, transfer one or more files, etc. The user may then trigger the action by pointing the IR port of the device 110 at the IR port of the target device 110, 105. The devices 110, 105 may then, upon completion of the IR trigger event, automatically establish the WLAN, Wi-Fi, Wi-Fi P2P, Wi-Fi-Direct, or other P2P group link and perform the action. For example, once the connection is formed, the transfer of files or data may be automatically performed, without the need for further authentication or confirmation from the user. Accordingly, establishing the WLAN connection may be transparent to the user and connection time may be reduced.

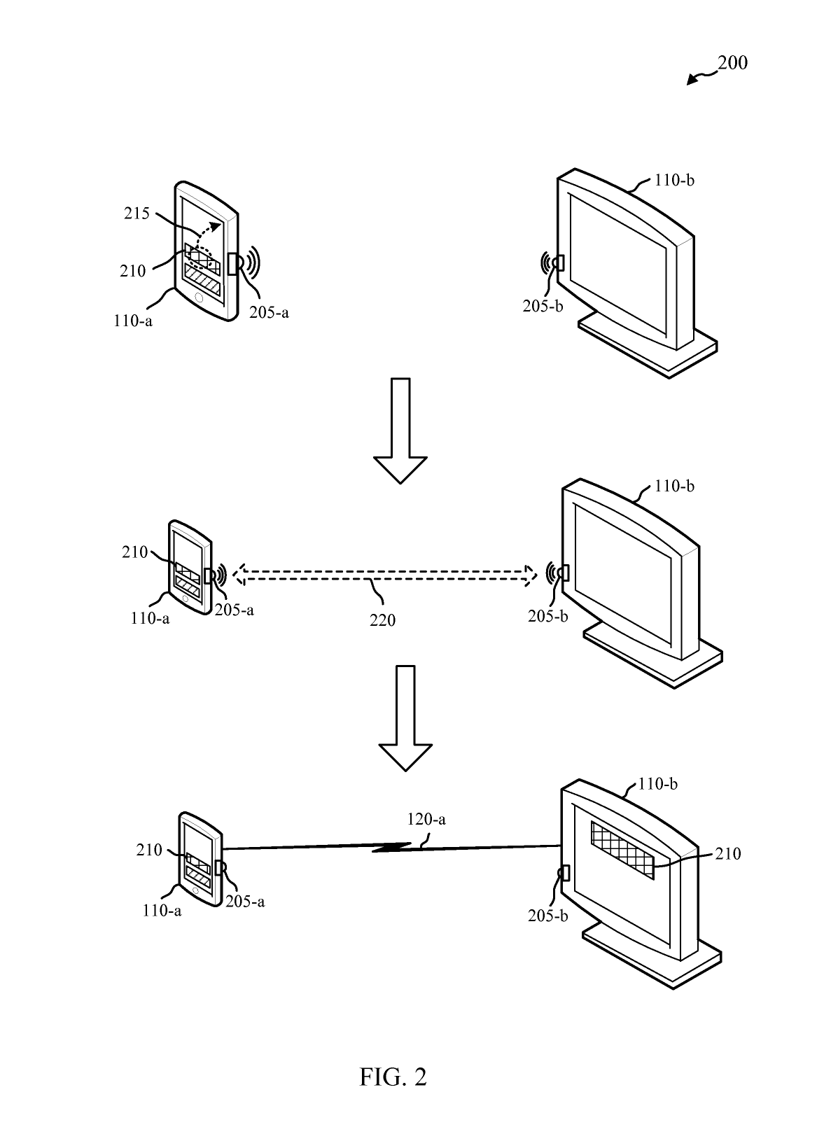

Referring now to FIG. 2, a diagram 200 illustrates an example of IR triggered radio communication between a first device 110-a and a second device 110-b according to various embodiments. In the example illustrated in FIG. 2, the first device 110-a may be a mobile device while the second device 110-b may be a display device (e.g., a projector, photo frame, computer monitor, TV, and the like). In other implementations, the first device 110-a may be a tablet, PDA, notebook, laptop, or other similar device, and the second device 110-b may be a printer, another mobile device, or other similar device.

The user of the mobile device 110-a may wish to perform an action such as transferring files, streaming content, etc., directed to the display device 110-b. The user may indicate an intent to form an IR triggered action, for example by selecting a file 210 and performing an action 215 associated with IR triggered sharing or streaming of the file 210 to another device. In the illustrated example, the action 215 may be a gesture indicating an intent by the user to share the selected file 210 with device 110-b. After or concurrently with the action 215, the user may direct the IR port 205-a of the mobile device 110-a at an IR port 205-b of the display device 110-b to establish an IR communication link between the devices 110-a and 110-b. In this example, the display device 110-b is assumed to be stationary such that to establish an IR link with another device 110-a, the IR port 205-a of the device 110-a can be moved or placed to align with the IR port 205-b of the device 110-b to form the IR link between the devices 110-a and 110-b. In other implementations, device 110-b may also be mobile, such that both devices 110-a and 110-b can be moved or placed to line up the IR ports 205 of the respective devices.

Once the IR ports 205-a, 205-b of devices 110-a, 110-b are aligned, trigger messages may be exchanged between the devices 110-a, 110-b over the IR communication link 220 to ensure a signal strength threshold is met and that both devices 110-a, 110-b are capable of forming the radio communication link, such as a WLAN (e.g., Wi-Fi, Wi-Fi P2P, Wi-Fi Direct, etc.) connection. Once the capability and intent of the devices 110-a, 110-b is confirmed by decoding an IR code in the trigger messages, a WLAN connection 120-a, such as a Wi-Fi Direct connection, can be established using connection initialization procedures, as will be described in greater detail below. Once the WLAN connection 120-a is formed, the selected file 210 may be automatically shared or transferred to the display device 110-b over the WLAN connection 120-a, as illustrated in FIG. 2 by the appearance of file 210 on a screen of the display device 110-b.

The implementation of an IR triggered P2P connection can eliminate the need for the initiating peer device, in this case device 110-a, to search for other network or peer devices, such as device 110-b. Rather, device 110-b can be chosen by the user by directing or pointing the IR port 205-a of the mobile device 110-a towards the IR port 205-b of another IR capable device 110-b, to establish an IR communication link 220. A WLAN connection 120-a may then be automatically formed, and the user may easily share files, data, etc., between the devices 110-a, 110-b.

In some embodiments, the user action 215 may be any of a variety of actions that can be predetermined or pre-programmed to indicate and initiate IR triggered actions by a device 110, such as a mobile device 110-a. For example, an application or program on the mobile device 110-a may be configured to display files, pictures, videos, documents, or other data structures that are available to share or transfer to another device, such as a printer, display device, etc. By selecting 215 one or more files 210, etc., and moving the selected file across the screen of device 110-a, the user may indicate an intention to share files with another device 110-b. In some embodiments, the user action 215 may include a gesture or another particular movement of the device 110-a (e.g., shaking, tilting, etc.), pressing or selecting a button on the device 110-a, selecting a menu item on the device 110-a, enabling a feature on the device 110-a, etc. The user action 215 may then automatically cause the IR port 205-a of device 110-a to transmit an IR trigger that indicates an intent and capability to form a WLAN connection when the IR ports 205-a, 205-b of the two devices 110-a, 110-b are aligned.

While FIG. 2 illustrates the example of IR triggered file transfer using a WiFi Direct connection 120, other examples may use other WLAN connections such as AP links 115 or perform other types of operations. For example, a user may indicate an intent to connect to a WLAN, such as by opening an application or program configured to automatically trigger the connection using IR. In other implementations, a user may simply point an IR port 205-a of device 110-a at another IR port, whereby a WLAN connection will be automatically established. Connecting to a WLAN in this way may eliminate the need for the user to manually select a WLAN and/or manually enter security information to establish the WLAN connection.

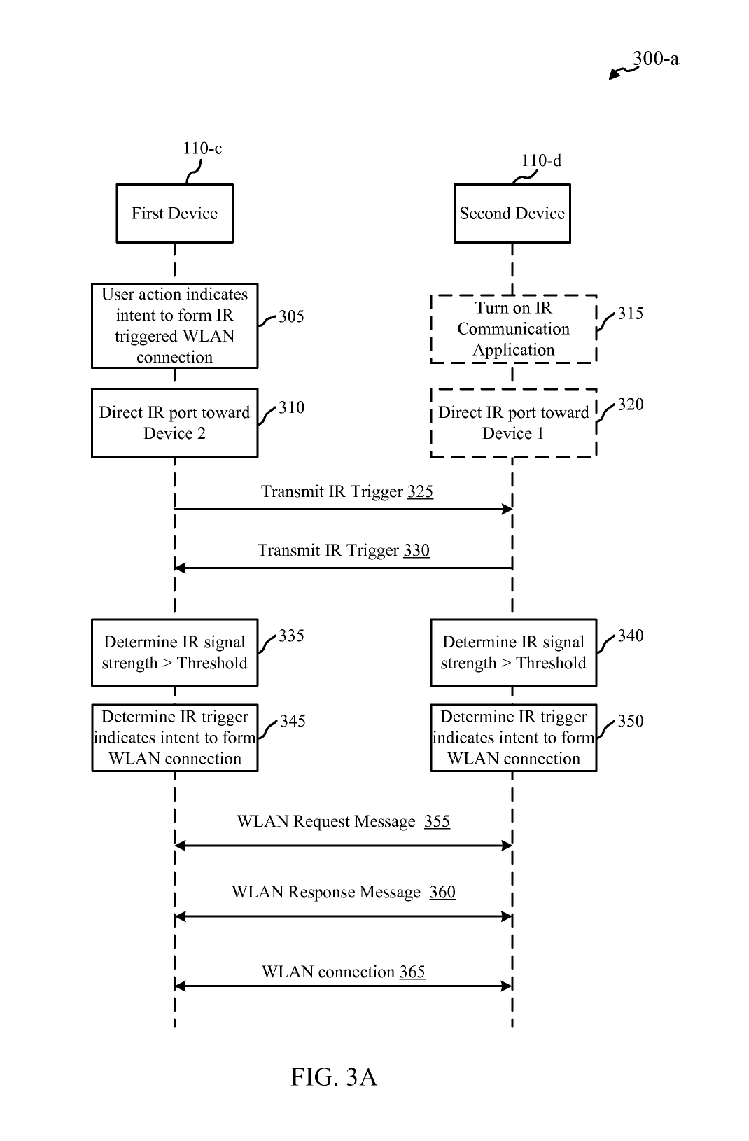

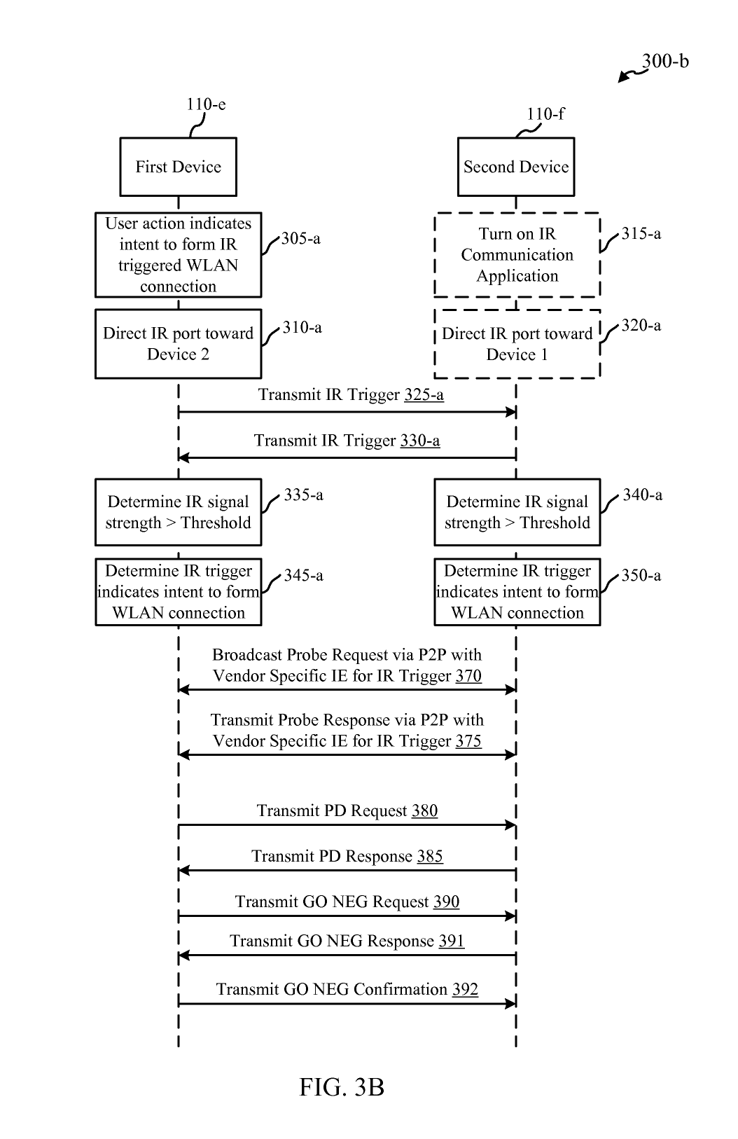

In reference to FIG. 3A, a flow diagram 300-a depicts an example of an IR triggered WLAN connection. A user of a first device 110-c, which may be an example of any one of the devices 110 described above, may want to establish a WLAN connection, share information and/or transfer files with a second device 110-d, which may also be an example of any of the devices 110 or APs 105 described above. A user may indicate an intent to establish an IR triggered WLAN connection with another device 110 or AP 105 via a user action 305, which may be an example of user action 215 described above in reference to FIG. 2. The user action 305 may be, in one example, enabling or selecting an IR communication application via a button or option in an application accessed on the first device 110-c. The user action 305 may also include enabling an IR triggered WLAN feature on the device 110-c. In one instance, the IR communication application may further provide the capability to designate files to select for file sharing/data transfer with another device, such as the second device 110-d. This capability may allow the user to perform a simple command, such as by swiping the selected file on a screen of the first device 110-c toward the other device 110.

Once the IR communication application is activated via the user action 305, the user may direct an IR port of the first device 110-c at an IR port of the second device 110-d to begin the IR link establishment procedure at block 310. In some embodiments, the user may first align the IR ports of the first device 110-c with the IR ports of the second device 110-d. The user may then indicate an intent to establish an IR triggered WLAN link with the second device 110-d via one or more user actions 305. In some cases, the user action 305 may include opening an application, enabling a feature, selecting files to transfer and swiping the selected files toward a target device, etc. In some embodiments, for instance where the second device 110-d is not stationary or has a non-continuously operating IR port (e.g., other mobile or battery-powered device, etc.), an IR communication application may be activated on the second device 110-d at block 315 and the IR port of the second device 110-d may be directed at the IR port of the first device 110-c at block 320.

In some embodiments, the user action 305 may include opening an application or program on the first device 110-c enabling file transfer to another device, such as the second device 110-d. The user may then select one or more files for transfer, and may move those selected files on the screen of the first device 110-c in a certain direction. Sensors of the first device 110-c may record and remember the direction of the user action, which may be user action 305, and when the IR port of the first device 110-c is aligned substantially in the direction of the user action, an IR triggered WLAN connection may be automatically initiated via steps 325, 330, 335, 340, 345, 350, 355, 360, and 365 as described below with device 110-d, and the selected files transferred. In this manner, possible unintended connections with other nearby devices can be mitigated.

Once a line of sight is established between the IR ports of the first device and the second device 110-c, 110-d, the first device 110-c may send an IR trigger 325 indicating support for a WLAN connection and an intention to form a WLAN connection to the second device 110-d. The second device 110-d may then respond by sending an IR trigger 330 back to the first device 110-c indicating support for the WLAN connection and affirmation or denial of the request. The two triggers may each be communicated over the IR communication link using predefined IR codes, for example 1010, 0101, or any other similar IR code. Each device 110-c, 110-d may confirm or determine if the IR signal strength of the IR link exceeds a predetermined threshold at blocks 335, 340. Each device 110-c, 110-d may then determine that the respective IR triggers (via the IR codes) sent at 325, 330 by devices 110-c, 110-d indicate an intent and capability to form a WLAN connection at blocks 345, 350. In some embodiments, the devices 110-c, 110-d may also exchange and verify device identifications (IDs) in preparation for setting up a WLAN connection at or before blocks 345, 350.

Upon confirming the IR signal strength and IR codes, both devices 110-c and 110-d can turn ON or activate their respective WLAN interfaces. The first device 110-c and the second device 110-d can then each broadcast a WLAN request message 355. In some embodiments, the WLAN request messages 355 may each include an information element (IE) (e.g., vendor specific IE, etc.) to indicate an IR based trigger for a WLAN connection. Upon receiving a WLAN request message 355, each device 110-c and 110-d may transmit a WLAN response message 360. In some embodiments, each WLAN response message 360 may include an IE, such as a vendor specific IE. Once device discovery has been performed using these techniques, establishment of the WLAN connection 365 may follow procedures known in the art for establishing a connection in various WLAN technologies, and as such will not be further detailed here.

In some embodiments, establishing the WLAN connection can include transmitting connection information to a third device, such as a device 110 or AP 105, to allow the third device to establish or aid in establishing the WLAN connection between the first device 110-c and the second device 110-d. In some cases, a printer or display device, for example, may rely on another device, such as an AP 105 or another device 110 for wireless communication capability. In these cases, the printer or display device may be in wired communication with a wireless capable device, such as an AP 105. It may then be beneficial to relay WLAN connection information through the third device to aid in establishing the WLAN connection. These techniques may be used to enable a device without wireless radio communication technology capability to appear to perform IR-triggered wireless operations (e.g., printing, display, etc.).

In some embodiments, it may be desirable to connect to a WLAN, for example at a coffee shop or other public establishment that offers public WLAN connections, without having to manually select a network and enter security information to establish the connection with the network. In some instances, coffee shops or other public establishments may want to regulate who connects to and uses a hosted WLAN. In these cases, a user wanting to connect to the WLAN may need to manually acquire an access code or password from a clerk at the establishment. In order to reduce the time taken to connect to the WLAN and/or obtain security information to do so, the WLAN AP 105 may be configured to allow an IR trigger WLAN connection to be established using the techniques described above. These techniques may provide ease of connection by users while maintaining proximity-based access security for the hosted WLAN.

Similar benefits may also be realized in other situations. For example, any user wanting to print certain documents, pictures, etc. via a WLAN hosted printer 110, may be able to use the above described techniques to automatically connect to the network that the desired printer is associated with and perform a simple act, such as moving the files on the user device 110 toward the printer 110, to effectuate printing of the selected materials. The user action 305 and aligning of the IR ports of the two devices 310 and/or 315 may be performed in any order, as described above. In some cases, the user device may be associated with a user account, such as a bank account or establishment-specific account. The IR trigger message sent by the user device 110 to the printer 110, for example, may include this account information to allow the account to be automatically accessed. In some cases, the account information may be associated or linked with the device ID or the ID may be associated with the account via one or more databases. For example, a student at a university could simply point and swipe files on a mobile device 110 toward the printer 110 and have the files automatically print, with the amount for the printing automatically deducted from the associated user account.

In reference to FIG. 3B, a flow diagram 300-b depicts another example of an IR triggered WLAN connection, and more particularly an IR triggered P2P connection. A user of device 1 110-e, which may be an example of any one of the devices 110 described above, may want to establish a P2P connection, such as a Wi-Fi Direct connection, share information and/or transfer files with device 2 110-f, which may also be an example of any of the devices 110 described above. A user of a device 1 110-e may perform an action 305-a indicating an intent for device 1 110-e to form an IR-triggered Wi-Fi Direct connection and/or perform other actions (e.g., transfer files, etc.) directed to device 2 110-f. Similarly to FIG. 3A, the user may then direct the IR port of device 1 110-e at the IR port of device 2 110-f at block 310-a, initiating the exchange and confirmation of IR triggers at 325-a, 330-a, 335-a, 340-a, 345-a, and 350-a. As described with reference to FIG. 3A, the second device 110-f may be stationary or mobile such that blocks 315-a and 320-a can be optionally performed to enable and direct the IR port of device 2 110-f towards device 1 110-e.

Upon confirming the IR signal strength and IR codes, both device 1 110-e and device 2 110-f can turn ON or activate their respective P2P interfaces. Device 1 110-e and device 2 110-f can then each broadcast a P2P Probe Request 370 with an information element (IE) (e.g., vendor specific IE, etc.) to indicate an IR based trigger for P2P connection. In some embodiments, a vendor specific IE may include the medium access control (MAC) address of the respective device. Upon receiving the P2P Probe Request 370, each device 110-e and 110-f may transmit a Probe Response 375. In some embodiments, this may enable the devices 110-e, 110-f to receive the other device's MAC Address. Broadcasting P2P Probe Requests 370 and transmitting/receiving Probe Responses 375 may be particular examples of broadcasting request messages 355 and transmitting/receiving response messages 360 as described above in reference to FIG. 3A.

The devices 110-e, 110-f may then compare MAC addresses and determine a P2P initiator device according to which device has the greater MAC address. In other implementations, devices 110-e, 110-f may exchange MAC addresses in another manner, such as via an additional or different message.

In the illustrated example, device 1 110-e may have a higher MAC address than the device 2 110-f and may initiate the P2P connection by transmitting a Provisional Discovery (PD) Request 380. Device 2 110-f may respond by transmitting a PD response 385. Device 1 110-e may then transmit a Group Owner Negotiation (GO Neg) Request 390, whereby device 2 110-f may respond by transmitting a GO Neg response 391. Device 1 110-e may then confirm election as the GO for the P2P connection by transmitting a GO Neg confirmation 392. Establishment of the P2P connection between the devices 110-e, 110-f may then be carried out using a push button configuration (PBC) to enable data encryption over the P2P connection as is well known in the art. In this way, a P2P connection can be formed without additional user action, such as entering security information or otherwise confirming the P2P. As can be appreciated, time to establish the P2P connect may be reduced by eliminating the need to search for another device 110-e, 110-f, etc. Once the P2P connection is formed, the devices 110-e, 110-f can deactivate their respective IR links and communicate via the established P2P connection.

In some embodiments, the devices 110-e, 110-f may receive the other device's MAC Address via the transmitted vendor specific IEs. The devices 110-e, 110-f may then compare MAC addresses and determine a P2P initiator device according to which device has the highest MAC address. Whichever device 110-e, 110-f has the highest MAC address can initiate the P2P connection, for example by transmitting a Provisional Discovery (PD) Request at 370. In other implementations, devices 110-e, 110-f may exchange MAC addresses in another manner, such as via an additional or different message.

In some embodiments, devices 110-e, 110-f may exchange MAC addresses for determining the P2P initiator device via the IR communication link instead of in IEs communicated over the P2P connection. In some embodiments, P2P IE intent values, for example, indicating an intent to form the WLAN connection, and/or identification of an operating channel (operating channel ID) or a listening channel (listening channel ID) for the WLAN connection may additionally or alternatively be exchanged over the IR communication link. The listening channel ID may indicate a channel by which device 110-c and/or 110-d may listen to receive information to establish the WLAN connection, such as P2P IE intent values. The operating channel ID may identify the channel for the WLAN connection. Exchanging the P2P IE intent values and the listening/operation channel identifications over the IR communication link may further speed up the WLAN connection process.

In some embodiments, establishing the P2P connection can include transmitting connection information to a third device, such as another device 110, to allow the third device to establish or aid in establishing the P2P connection between the device 1 110-e and the device 2 110-f. In some cases, it may then be beneficial to relay P2P connection information through the third device to aid in establishing the P2P connection.

For ease of explanation, FIGS. 3A and 3B describe IR-triggered WLAN connections and/or actions. However, these IR-triggered radio communication techniques may be applied to other radio communication technologies beyond Wi-Fi or Wi-Fi Direct (e.g., Bluetooth, etc.).

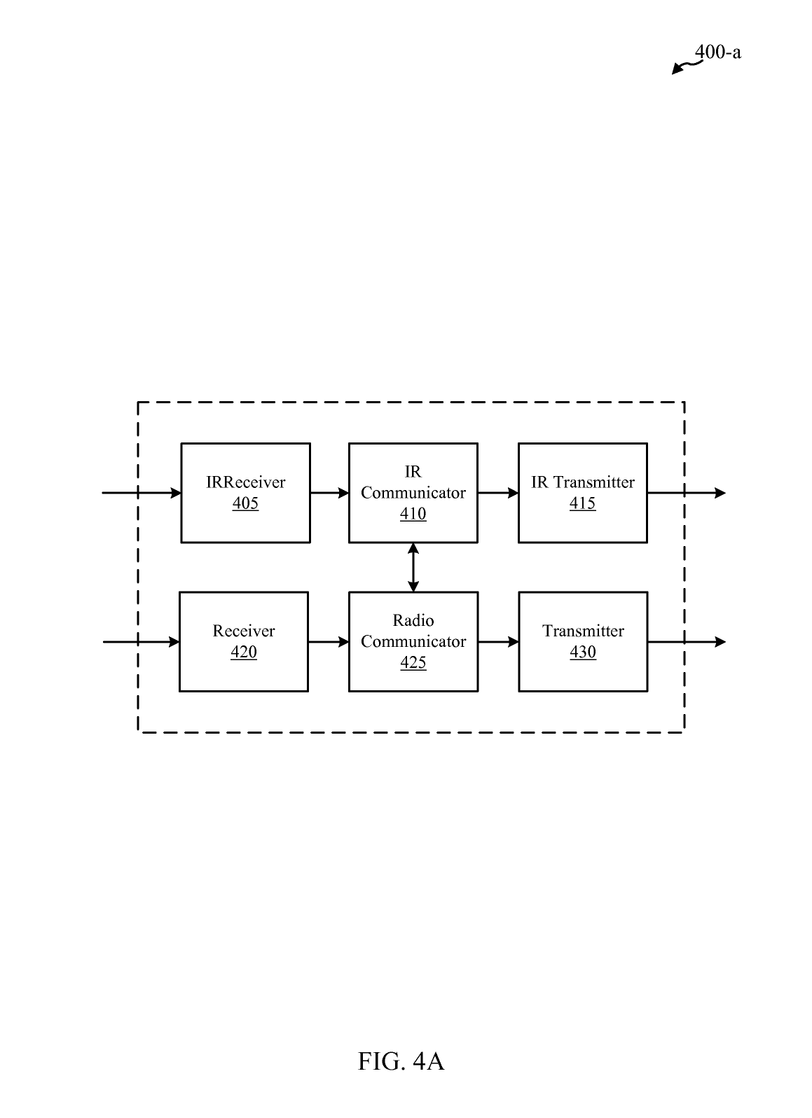

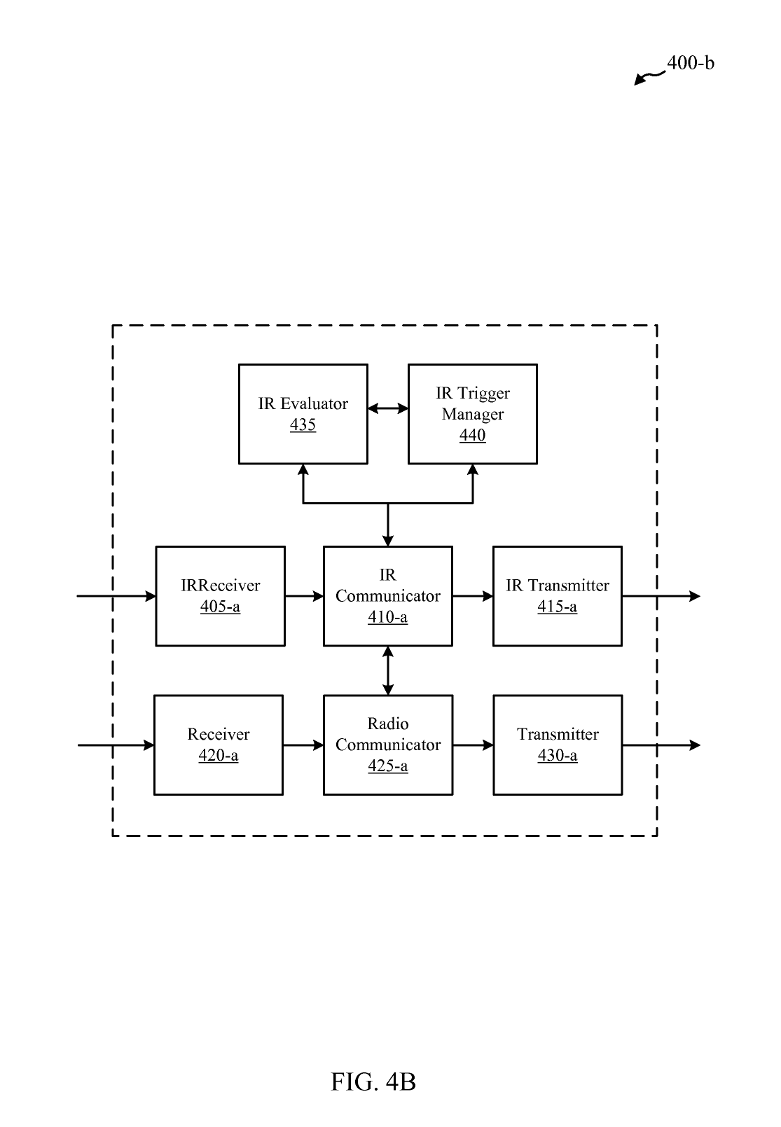

FIG. 4A, shows a block diagram illustrating an example of a device 400-a that may be configured for utilizing an IR link to trigger and setup a radio communication link with another device in accordance with various embodiments. The device 400-a may be an example of one or more aspects of the devices 110 described with reference to FIG. 1, FIG. 2, FIG. 3A, or FIG. 3B. The device 400-a may include an IR receiver 405, an IR communicator 410, an IR transmitter 415, a receiver 420, a radio communicator 425, and/or a transmitter 430, each of which, in embodiments, may be communicably coupled with any or all of the other modules.

The IR receiver 405 may be used to receive various types of data and/or control signals over an IR communication link, such as IR communication link 220 as shown in FIG. 2. The IR transmitter 415 may be used to transmit various types of data and/or control signals over an IR communication link, such as IR communication link 220 as shown in FIG. 2. As such, the IR receiver 405 and/or IR transmitter 415, either alone or in combination with other modules, may be means for communicating IR messages including IR triggers and/or WLAN link control/establishment information to establish an IR triggered WLAN connection with other devices as described herein. In some embodiments, the IR receiver 405 and the IR transmitter 415 may be implemented in a single device or module, such as an IR port. In other cases, they may be separate devices or modules.

Device 400-a may also include a receiver 420 and a transmitter 430 that may be used for communication of various types of data and/or control signals over a wireless communications system such as the wireless communications system 100 as shown in FIG. 1, and/or over one or more radio communications links, such as links 115 and/or links 120 of FIGS. 1 and 2. As such, the receiver 420 and/or the transmitter 430 either alone or in combination with other modules, may be means for communicating, for example, over a WLAN as described herein.

The receiver 420 and the transmitter 430 may make up a single radio of device 400-a that may be configured for supporting an IR triggered WLAN connection. For the sake of explanation, device 400-a is only shown with a single radio; however, it should be appreciated that device 400-a may include multiple radios that support concurrent communication over multiple WLAN channels (e.g., multiple IR-triggered WLAN communication links).

The IR communicator 410 of device 400-a may, upon receipt of a user action indicating an intent to establish an IR triggered WLAN connection, configure a trigger message to send to another IR/WLAN capable device to initiate an IR link, as described above in reference to FIGS. 2-3B. The user action indicating an intent to establish an IR triggered WLAN connection may also be performed in conjunction with aligning an IR port (e.g., IR transmitter 415 and IR receiver 405) of device 400-a with an IR transmitter/receiver port of a target device to establish an IR link.

The IR communicator 410, via the IR receiver 405, may receive a response trigger message from the target device. Upon confirming the IR link and the capability of the target device to establish the WLAN connection, the IR communicator 410 may then indicate to the radio communicator 425 to initialize the WLAN connection. The radio communicator 425, in conjunction with the receiver 420 and transmitter 430, may then initialize the WLAN communication via the procedures described above in reference to FIGS. 3A and 3B. In some cases, initialization of the WLAN connection may be carried out in part by the IR communicator 410 via the IR transmitter 415 and IR receiver 405.

In some cases, the IR communicator 410 and/or the radio communicator 425 may further provide the capability to transfer files indicated by the user over the WLAN connection via the receiver 420 and transmitter 430. This capability may allow the user to perform a simple command, such as by swiping the selected file on a screen of device 400-a toward the target device. The user act and aligning of the IR ports of the two devices may be performed in any order, as described above in reference to FIG. 3A.

The device 400-a may also act as a target device in the IR trigger WLAN connection techniques described above. In such a case, the IR communicator 410 may receive an IR trigger from another device, such as device 110 or another device 400-a. The IR communicator 410 may determine that the sender device is attempting to establish an IR triggered WLAN connection via the received trigger message. The IR communicator 410 may configure a response trigger message to confirm the request and communicate the trigger response to the transmitter 415. The IR transmitter 415 may then send the trigger message to the sending device via the IR link. The sending device, after receiving the response trigger message, may then initiate communication over a WLAN link. The receiver 420 and transmitter 430 may then facilitate establishment of the WLAN connection.

In some embodiments, in either the initiating device or the target device, once the WLAN connection is established, one or more of the IR receiver 405, IR communicator 410, and the IR transmitter 415 may be powered or turned off to, for example, conserve power of the device 400-a.

FIG. 4B, shows a block diagram illustrating an example of another device 400-b that may be configured for utilizing an infrared (IR) link to trigger and setup a radio communication link with another device in accordance with various embodiments. The device 400-b may be an example of one or more aspects of the devices 110 of FIG. 1, FIG. 2, FIG. 3A, or FIG. 3B, and/or device 400-a of FIG. 4A. The device 400-b may include an IR receiver 405-a, an IR communicator 410-a, an IR evaluator 435, an IR trigger manager 440, an IR transmitter 415-a, a receiver 420-a, a radio communicator 425-a, and/or a transmitter 430-a, each of which, in embodiments, may be communicably coupled with any or all of the other modules.

The IR receiver 405-a, IR transmitter 415-a, receiver 420-a, radio communicator 425-a, and transmitter 430-a, may be, respectively, examples of the IR receiver 405, IR transmitter 415, receiver 420, radio communicator 425, and transmitter 430, described above in reference to FIG. 4A above. As such, for the sake of brevity, these components will not be individually described again here.

The IR trigger manager 440 in conjunction with the IR communicator 410-a of device 400-b may, upon receipt of a user action indicating an intent to establish an IR triggered WLAN connection, configure a trigger message to send to another IR/WLAN capable device to initiate an IR link, as described above in reference to FIGS. 2-4A. The trigger message may be configured by the IR trigger manager 440 to indicate support for a WLAN connection and an intention to form a WLAN connection with the target device. The user action indicating an intent to establish an IR triggered WLAN connection may also be performed in conjunction with aligning the IR transmitter 415-a/receiver 405-a of device 400-b with an IR transmitter/receiver of another device. Once the IR transmitter 415-a and IR receiver 405-a of device 400-b and a target device are aligned, the IR trigger message may be communicated from the IR trigger manager 440 to the IR transmitter 415-a to initiate the IR triggered WLAN connection. In some cases, the IR trigger message may also be communicated to or through the IR communicator 410-a to the IR transmitter 415-a. The IR communicator 410-a may perform some or all of the configuration of the IR trigger message in conjunction with the IR trigger manager 440.

Via the IR receiver 405-a, the IR communicator 410 may receive an IR trigger message from the target device. The two triggers may each be communicated over the IR communication link using predefined IR codes, for example 1010, 0101, or any other predefined IR code indicating an IR-triggered action. The IR evaluator 435 may then determine if the IR signal strength of the IR link exceeds a predetermined threshold, and confirm that the other device is otherwise capable of forming the WLAN connection. The IR signal strength may be determined, for example, by a received power of the trigger message from the target device. Further, the trigger message from the target device may indicate capability to form the requested WLAN connection. In some embodiments, device 400-b may also exchange and verify device identifications (IDs) with the target device in preparation for setting up a WLAN connection, with the exchange of device IDs being carried out by the IR receiver 405-a and IR transmitter 415-a.

Upon confirming the IR link and the capability of the target device to establish the WLAN connection, the IR communicator 410-a may then indicate to the radio communicator 425-a to initialize the WLAN connection. The radio communicator 425-a, in conjunction with the receiver 420-a and transmitter 430-a, may then establish the WLAN connection via the procedures described above in reference to FIGS. 3A and 3B. In some cases, part of the initialization of the WLAN connection may be carried out by the IR communicator 410-a via the IR transmitter 415-a and IR receiver 405-a.

In some cases, the IR communicator 410-a and/or the radio communicator 425-a may further provide the capability to transfer files indicated by the user over the WLAN connection via the receiver 420-a and transmitter 430-a. This capability may allow the user to perform a simple command, such as by swiping the selected file on a screen of device 400-b toward the target device. The user act and aligning of the IR ports of the two devices may be performed in any order, as described above in reference to FIG. 3A.

The device 400-b may also act as a target device in the IR trigger WLAN connection described above. In such a case, the IR communicator 410-a may receive an IR trigger from another device, such as device 110 or another device 400-a, 400-b. The IR evaluator 435 may determine that the sending device is attempting to establish an IR triggered WLAN connection via the received trigger message. The IR trigger manager 440 may then configure a response trigger message to confirm the request and communicate the trigger response to the IR transmitter 415. In some cases the response trigger message may also be communicated to or through the IR communicator 410-a. The IR transmitter 415-a may then send the trigger message to the sending device via the IR link. The sending device, after receiving the response trigger message, may then initiate WLAN connection procedures as described above with reference to FIGS. 3A and 3B via receiver 420-a and transmitter 430-a.

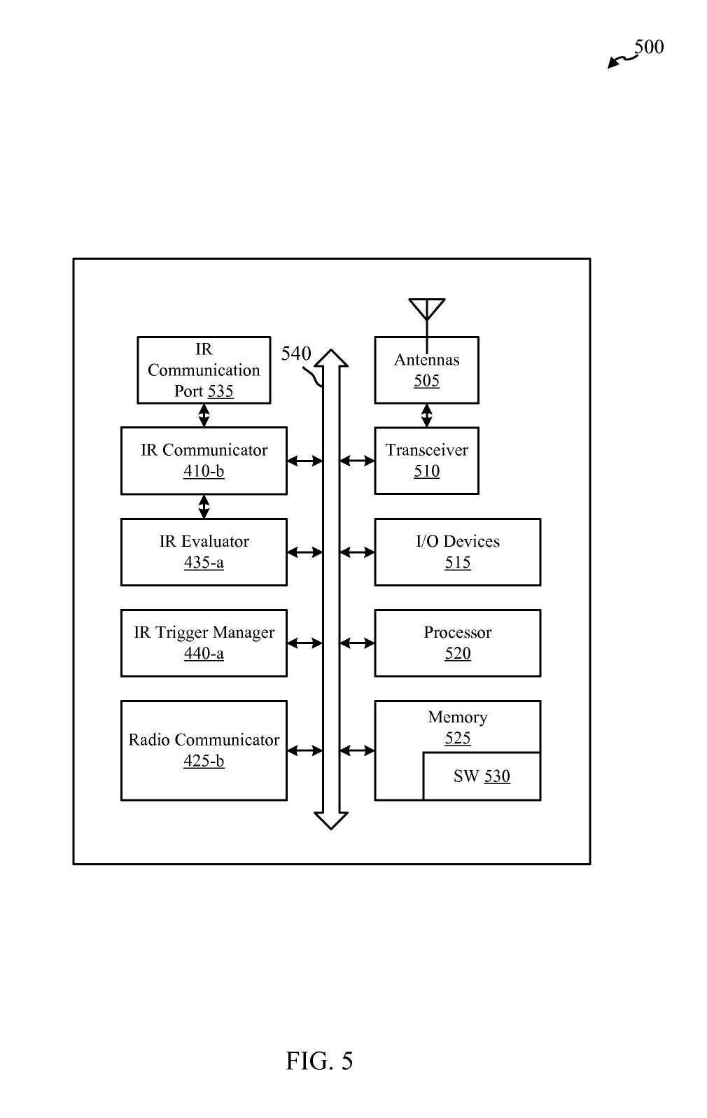

FIG. 5 is a block diagram a device 500 configured for utilizing an infrared (IR) link to trigger and setup a radio communication link with another device in accordance with various embodiments. Device 500 may be an example of one or more aspects of the devices 110 described with reference to FIG. 1, FIG. 2, FIG. 3A, or FIG. 3B, APs 105 described with reference to FIG. 1, or devices 400 described with reference to FIG. 4A or FIG. 4B. The device 500 may have any of various configurations, such as personal computers (e.g., laptop computers, netbook computers, tablet computers, etc.), smartphones, cellular telephones, PDAs, wearable computing devices, digital video recorders (DVRs), internet appliances, routers, gaming consoles, e-readers, display devices, printers, etc. The device 500 may have an internal power supply (not shown), such as a small battery, to facilitate mobile operation.

The device 500 includes antenna(s) 505, a transceiver module 510, memory 525, a processor 520, and I/O devices 515, which each may be in communication, directly or indirectly, with each other, for example, via one or more buses 540. The transceiver module 510 is configured to communicate bi-directionally, via the antennas 505 with one or more wired or wireless links, such as any of links 115, 120 of FIGS. 1 and 2, as described above. The transceiver module 510 may include a modem configured to modulate the packets and provide the modulated packets to the antennas 505 for transmission, and to demodulate packets received from the antennas 505. The transceiver module 510 may be configured to maintain multiple concurrent communication links using the same or different radio interfaces (e.g., Wi-Fi, cellular, etc.). The device 500 may include a single antenna 505, or the device 500 may include multiple antennas 505. The device 500 may be capable of employing multiple antennas 505 for transmitting and receiving communications in a multiple-input multiple-output (MIMO) communication system.

The memory 525 may include random access memory (RAM) and read-only memory (ROM). The memory 525 may store computer-readable, computer-executable software code 530 containing instructions that are configured to, when executed, cause the processor 520 to perform various functions described herein. Alternatively, the software 530 may not be directly executable by the processor 520 but be configured to cause the computer (e.g., when compiled and executed) to perform functions described herein. The processor 520 may include an intelligent hardware device, e.g., a central processing unit (CPU), a microcontroller, an application specific integrated circuit (ASIC), etc.

According to the architecture of FIG. 5, the device 500 further includes an IR communication port 535, an IR communicator 410-b, an IR evaluator 435-a, an IR trigger manager 440-a, and a radio communicator 425-b. By way of example, these modules may be components of the device 500 in communication with some or all of the other components of the device 500 via bus 540. Additionally or alternatively, functionality of these modules may be implemented via the transceiver 510, as a computer program product stored in software 530, and/or as one or more controller elements of the processor 520. In some embodiments, the IR communicator 410-a, the IR evaluator 435-a, the IR trigger manager 440-a, and/or the radio communicator 425-b may be implemented as subroutines in memory 525/software 530, executed by the processor 520. In other cases, these modules may be implemented as sub-modules in the processor 520 itself.

The IR communication port 535, which may include similar functionality as IR receivers 405 and IR transmitters 415 of devices 400-a and 400-b, may allow the device 500 to send and receive messages over one or more IR links, as similarly described in reference to FIGS. 4A and 4B above. The IR communicator 410-b, in conjunction with the IR evaluator 435-a, the IR trigger manager 440-a, IR communication port 535, and the radio communicator 425-b may allow device 500 to trigger, via IR, a WLAN communication link with another device, such as any of devices 110, devices 400, or APs 105 described previously. These modules may communicate via bus 540 with the antennas 505, the transceiver 510, the I/O devices 515, the processor 520, and/or the memory 525 to receive a user action indicating an intent to form an IR triggered WLAN communication link with another device and to configure and establish the IR triggered WLAN link, via techniques described above in reference to FIGS. 1-4B. The IR communicator 410-a and the radio communicator 425-b may be examples of IR communicators 410 and radio communicators 425, respectively, of FIGS. 4A and 4B. The IR evaluator 435-a and the IR trigger manager 440-a may be examples of the IR evaluator 435 and IR trigger manager 440, respectively, of FIG. 4B.

The IR communicator 410-b may transmit and/or receive via IR communication port 535 one or more IR trigger messages indicating an intent and capability to form an IR triggered WLAN connection with another device. The IR evaluator 435-a may determine the contents of a received IR trigger message, and the IR trigger manager 440-a may configure an IR trigger message to be sent to another device. The IR evaluator 435-a and the IR trigger manager 440-a may coordinate via the IR communicator 410-b to establish an IR link with another device and confirm intent and capability to form a WLAN connection with that device, via techniques described above in reference to FIGS. 4B.

Once intent and capability of the two devices to form an IR triggered WLAN connection are confirmed, the IR communicator 410-b may indicate to the radio communicator 425-b to begin establishing the WLAN connection, via techniques also described above in reference to FIGS. 4A and 4B. The radio communicator 425-b may then communicate with the transceiver 510 and antennas 505 via the bus 540 to communicate WLAN configuration information with the intended device, via techniques described above in reference to FIGS. 3A and 3B. In some embodiments, some or all of the functionality of the radio communicator 425-b may be implemented in whole or in part in the memory 525, software 530, processor 520 and/or the transceiver 510.

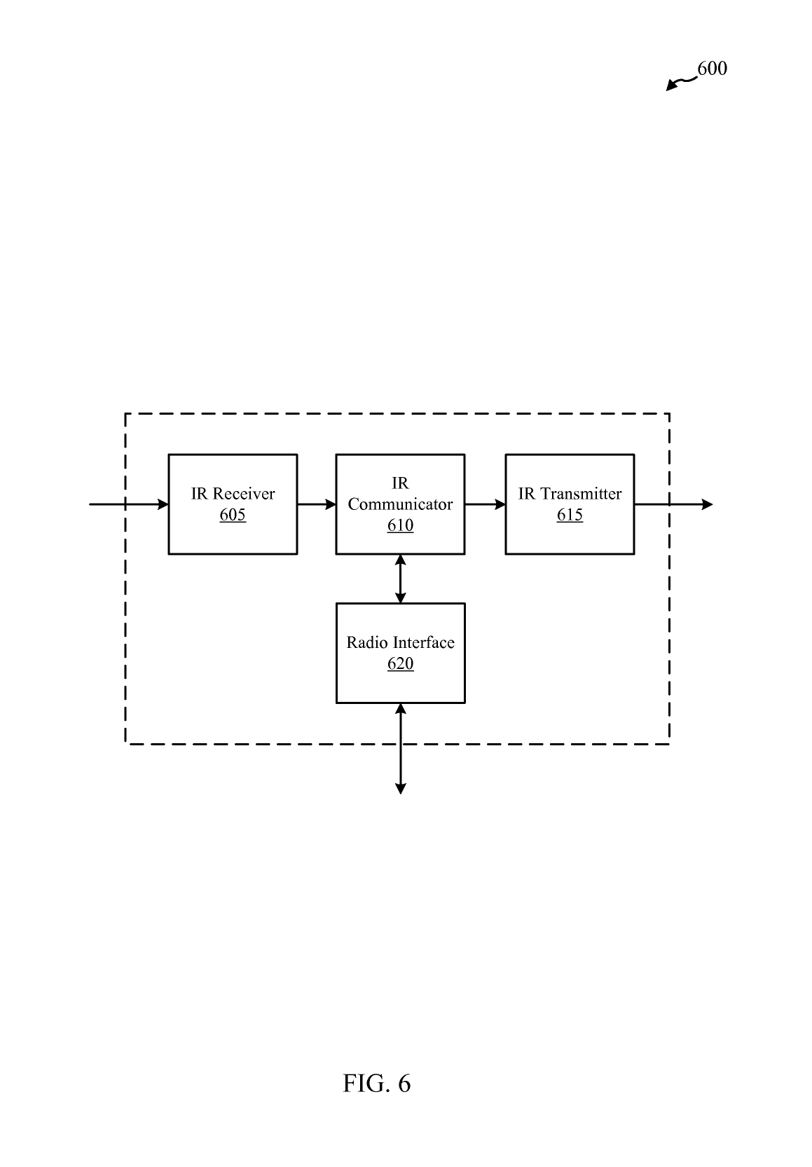

FIG. 6 shows a block diagram illustrating an example of a device 600 that may be configured for utilizing an infrared (IR) link to trigger and setup a radio communication link with another device in accordance with various embodiments. The device 600 may be an example of one or more aspects of devices 110 described with reference to FIG. 1 FIG. 2, FIG. 3A, or FIG. 3B, device 400 of FIG. 4A or FIG. 4B, and/or device 500 of FIG. 5. The device 600 may further implement some or all of the IR triggered WLAN connection functionality as described above in reference to FIGS. 2-5. The device 600 may include an IR receiver 605, an IR communicator 610, an IR transmitter 615, and/or a radio interface 620, each of which, in embodiments, may be communicably coupled with any or all of the other modules.

The IR receiver 605, the IR communicator 610, and/or the IR transmitter 615 may include some or all of the functionality described above with reference to, respectively, the IR receivers 405, the IR communicators 410, and the IR transmitters 415 of devices 400-a, 400-b, 500 described above in reference to FIGS. 4A, 4B, and 5. In some embodiments, the IR receiver 605 and the IR transmitter 615 may be an example of the IR communication port 535 of device 500 described above in reference to FIG. 5. Accordingly, these components/modules will not be individually described further here.

In some embodiments, device 600 may be an add-on module or device that can be attached to a wireless capable device, for example via one or more communication ports of the device, to enable the device to communicate via IR. In this way, for example, an older generation device without IR capability may be retrofitted with device 600 to enable the device to practice techniques for establishing an IR triggered WLAN connection with another device, such as device 110, 400, or 500 as described above.

For example, a printer or a display device 110, may not have IR capability. By attaching device 600 to an existing communication port of the printer or display 110, such as a USB port, for example, the device 110 may then be enabled to establish an IR triggered WLAN link with another device via the techniques described above in reference to FIGS. 2-5. Device 600 may be particularly useful when, for example, an older model display device or printer is already installed at a particularly location, such as a coffee shop or library. Via the implementation of one or more of devices 600, a low cost solution to providing IR triggered WLAN connections, such as for easier WLAN access or file/data sharing may be realized.

Accordingly, the IR communicator 610 of device 600 may send and receive IR trigger messages via the IR receiver 605 and the IR transmitter 615 to establish an IR triggered WLAN communication link with another device, such as devices 110, 400-a, 400-b, 500, and/or APs 105. Once the IR link is established and the intent and capability to form an IR triggered WLAN connection confirmed, the IR communicator 610 may communicate instructions to initialize the WLAN connection to the radio interface 620. The radio interface 620 may then, for example, communicate the instructions to form a WLAN connection to a host wireless device, such as device 110 or AP 105, via one or more communication ports of the host wireless device. The host wireless device may then establish the WLAN connection using its own radio communication interface and/or modules/hardware. In some embodiments, the radio interface 620 may implement some or all of the functionality of the radio communicators 425 of devices 400-a, 400-b, or 500 described above in reference to FIGS. 4A, 4B, and 5.

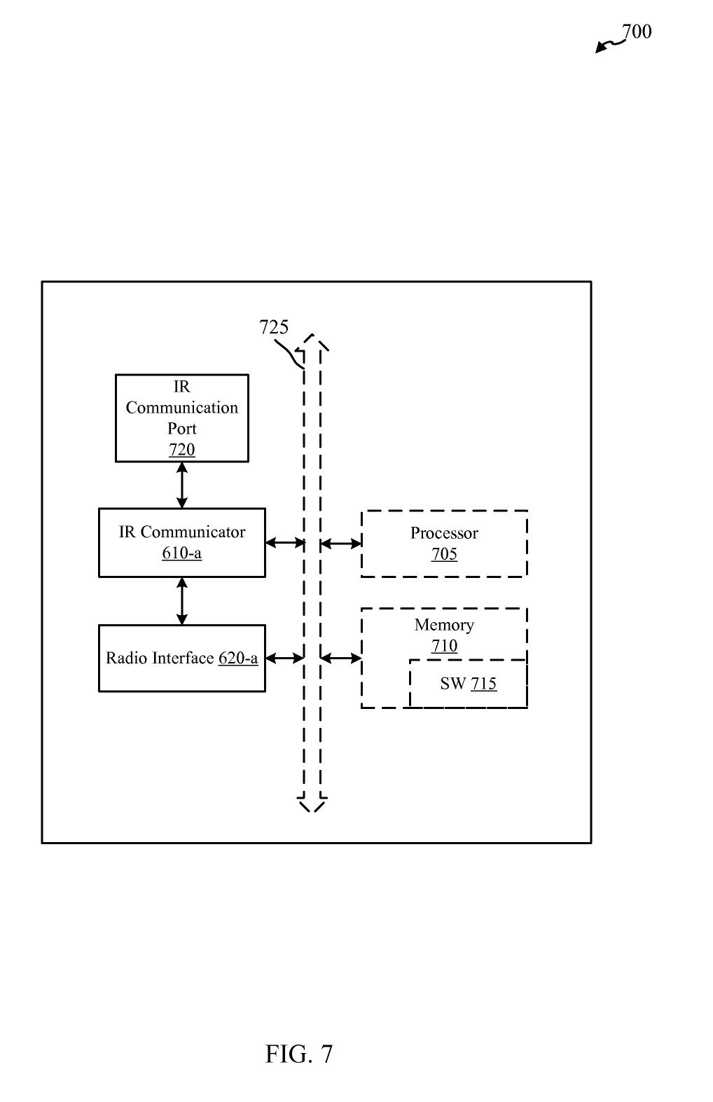

FIG. 7, is a block diagram of a device 700 configured for utilizing an IR link to trigger and setup a radio communication link with another device in accordance with various embodiments. The device 700 may be an example of one or more aspects of devices 110 described with reference to FIG. 1, FIG. 2, FIG. 3A, or FIG. 3B, device 400 of FIG. 4A or FIG. 4B, device 500 of FIG. 5, and/or device 600 of FIG. 6. The device 700 may have any of various configurations, such as personal computers (e.g., laptop computers, netbook computers, tablet computers, etc.), smartphones, cellular telephones, PDAs, wearable computing devices, etc. The device 700 may have an internal power supply (not shown), such as a small battery, to facilitate mobile operation.

The device 700 may include a memory 710, which further may include random access memory (RAM) and read-only memory (ROM). The memory 710 may store computer-readable, computer-executable software code 715 containing instructions that are configured to, when executed, cause the processor 705 to perform various functions described herein. Alternatively, the software 715 may not be directly executable by the processor 705 but be configured to cause the computer (e.g., when compiled and executed) to perform functions described herein. The processor 705 may include an intelligent hardware device, e.g., an at least one central processing unit (CPU), a microcontroller, an application specific integrated circuit (ASIC), etc.

According to the architecture of FIG. 7, the device 700 further includes an IR communication port 720, an IR communicator 610-a, and a radio interface 620-a. By way of example, some or all of these components of device 700 may be in communication with some or all of the other components of the device 700 via bus 725. Additionally or alternatively, functionality of, for example, the IR communicator 610-a and/or the radio interface 620-a may be implemented as a computer program product stored in software 715, and/or as one or more controller elements of the processor 705.

The IR communication port 720, which may be an example of the IR receiver 605, combined with the IR transmitter 615 of device 600, may allow the device 700 to send and receive messages over one or more IR links, as similarly described in reference to FIGS. 4A-6. The IR communicator 610-a, in conjunction with the radio interface 620-a and the IR communication port 720, may allow device 700 to trigger, via IR, a WLAN communication link with another device, such as any of devices 110, 400, 500, 600, or APs 105 described previously. These components may communicate via bus 725 with the processor 705, and/or the memory 710. Device 700 may receive a user action indicating an intent to form an IR triggered WLAN communication link with another device from a host device, which may be incorporate some or all of the aspects of devices 110, 400, 500, and/or 600 as described above. This indication may be communicated to the radio interface 610-a, which can then trigger IR communications via the IR communicator 610-a and the IR communication port 720. In this way, a host device coupled to device 700 may configure and establish an IR triggered WLAN link with another device, via techniques described above in reference to FIGS. 2-6.

In some embodiments, the IR communicator 610-a may be an example of IR communicator 410, 410-a, 410-b, 610 of FIGS. 4A-6. In addition, the IR communication port 720 may be an example of IR communication port 535 of FIG. 5. In some cases, the radio interface 620-a my be an example of radio interface 620 of FIG. 6, and/or may incorporate some or all of the functionality of radio communicator 425 of FIGS. 4A-5.

The components of devices 400-a, 400-b, 500, 600, and 700 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the devices 400-a, 400-b, 500, 600, and 700.

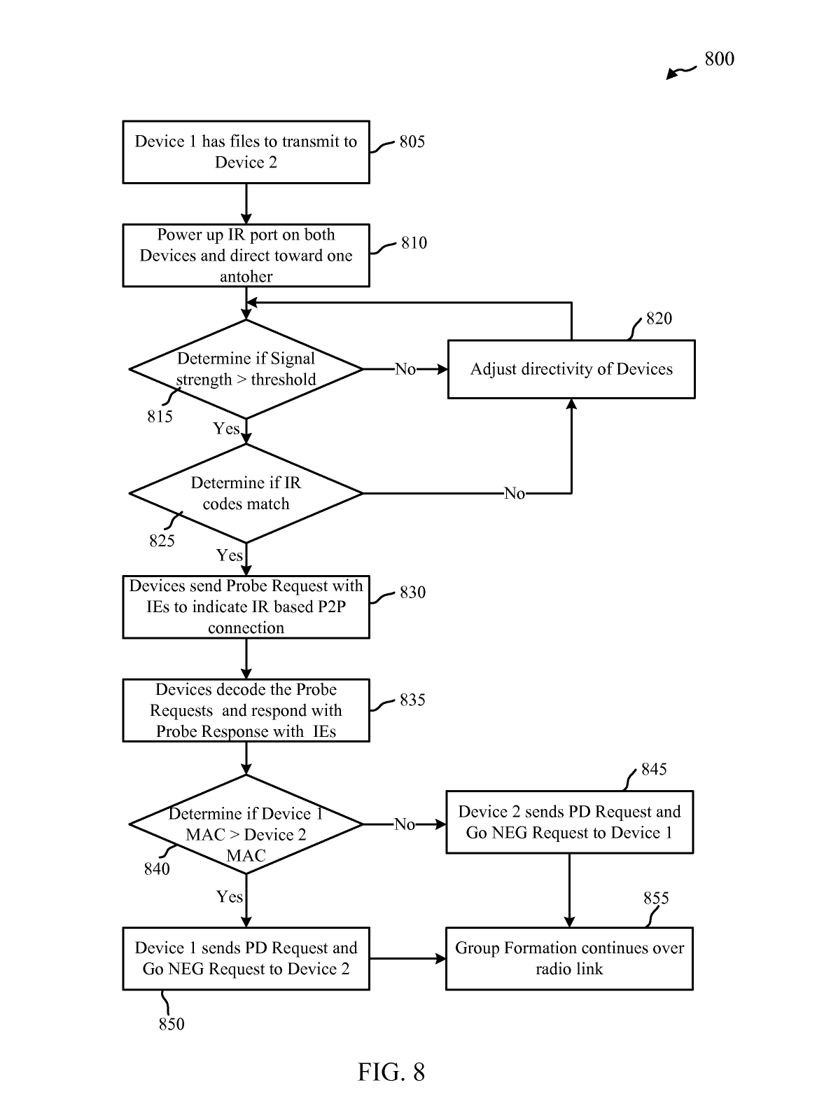

FIG. 8 illustrates a process 800 that may be implemented by an IR/WLAN capable device, such as devices 110, 400, 500, 600, or 700 of FIGS. 1-7 as described above, to utilize an IR link to trigger and setup a radio communication link with another device, such as device 110, 400, 500, 600, or 700, or APs 105 of FIGS. 1-7, in accordance with various embodiments.

The process 800 may begin at block 805, with a first device having files to transmit/share with a second device. The process may proceed to block 810, where an IR port of the first device and the second device may be activated and directed toward one another. In some cases, where for instance, the second device is stationary or has an IR port that is configured to constantly be on, only the IR port of the first device may need to be turned on. In some cases, the IR port of the first device may be turned on or activated by any action taken by a user of the first device that indicates an intent to establish an IR triggered WLAN connection. For example, the user action may include the user selecting certain files to transfer to the second device and somehow indicating movement of the files toward the second device, such as by swiping the selected files across the screen of the first device. The user act and aligning of the IR ports of the two devices may be performed in any order, as described above in reference to FIG. 3A.

The process 800 may then proceed to block 815, where the first device, and/or the second device, may determine if the IR signal strength is above a threshold. If the IR signal strength is not greater than the threshold, process 800 may proceed to block 820, where the directivity of the two devices may be adjusted to establish a better IR communication link. After block 820, process 800 may return to block 815 where it is again determined if the IR signal strength is above a threshold. This loop will continue as long as the IR signal strength is not greater than the threshold value. In some cases, after a certain number of iterations, if the signal strength never exceeds the threshold, the IR triggered WLAN connection may be abandoned, or an application or program directing the IR triggered WLAN link may be restarted. In some cases, this event will trigger a message to be indicated to the user, such as via a screen of the first and/or second devices.

If the IR signal strength does exceed the threshold at block 815, the process may proceed to block 825, where it can be determined if the IR codes sent from the two devices match. If the codes do not match, for example because of faulty transmission/reception due to misalignment of the IR ports of the respective devices, process 800 can proceed back to block 820, where the directivity of the devices can be adjusted. The process 800 will then continue to block 815, as described above, and will iterate until the two conditions of blocks 815 and 825 are met. If the IR codes do match, the process can proceed to block 830, where the devices can each enable their respective WLAN interfaces and transmit Probe Request messages with IEs indicating an intent to form the IR-triggered P2P connection. The devices may then each decode the Probe Requests and respond with Probe Response messages that each contain IEs at block 835.

Process 800 may then continue to block 840 if the MAC address of device 1 is greater than the MAC address of device 2. If the MAC address of device 1 is greater, than process 800 may continue to block 850 where device 1 can send a PD Request and a GO Neg request to device 2. Device 2 may then respond by sending a PD Response and a GO Neg Response message to device 1 to initialize the P2P group connection, upon reception of which device 1 can send a GO confirmation message to device 2. Process 800 may then continue to block 855 where P2P group formation procedures may be carried out over the P2P connection via the techniques described above in reference to FIG. 3B.

If the MAC address of device 1 is not greater than the MAC address of device 2 at block 840, process 800 may proceed to block 845, where device 2 can initiate the P2P group connection by sending a PD Request and a GO Neg message to device 1. Device 1 may then respond by sending a PD Response and a GO Neg Response message to device 2 to initialize the P2P group connection, upon reception of which device 2 can send a GO confirmation message to device 2. At that point, process 800 may proceed to block 855, where P2P group formation procedures may be carried out over the P2P connection.

In some embodiments, the P2P group formation procedures, as described in reference to blocks 830-855 may be in part carried out over the IR link. Similarly, in reference to blocks 830-855, a P2P group connection can be established via an IR trigger to share one or more files selected by a user between device 1 and device 2. While the process 800 is described with reference to establishing a P2P connection, it should be appreciated that similar techniques may be carried out using any radio communication technology, and process 800 should not be limited to a P2P group connection.

The process flow 800 described above is only given as an example. The various blocks of process 800 may be rearranged or omitted depending on channel needs, traffic considerations, IR and WLAN channel conditions, and other similar considerations.

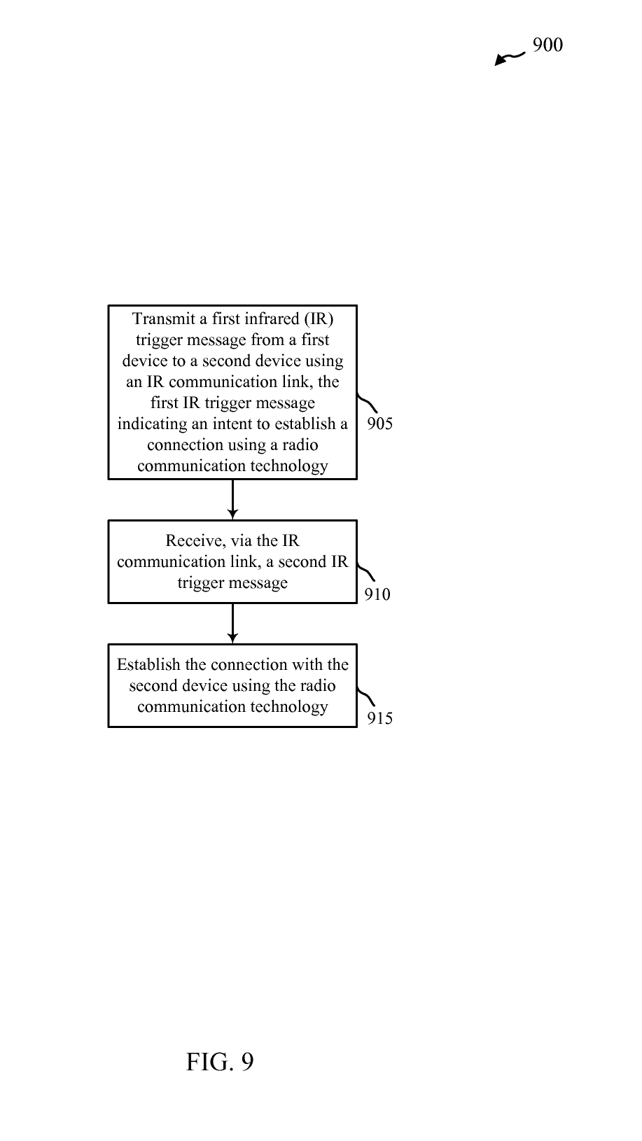

FIG. 9 is a flowchart illustrating an embodiment 900 of a method of establishing an IR triggered WLAN link. At block 905, a first device, such as device 110, 400, 500, 600, or 700, as described above, may transmit a first IR trigger message to a second device or AP using an IR communication link, where the first IR trigger message indicates an intent to establish a connection using a radio communication technology.

At block 910, the first device may receive, via the IR communication link, a second IR trigger message. The second IR trigger message may, for example, match the first IR trigger message or may indicate an ability of the second device or AP to form an IR-triggered WLAN connection.” The first and second IR trigger messages may be examples of messages 325, 330 of FIGS. 3A or 3B.

Then, at block 915, the first device may establish the connection with the second device using the radio communication technology. The radio communication link may be established, for example, through communication of the WLAN Request Message 355, WLAN Response message 360, and/or the WLAN connection 365 of FIG. 3A, and/or communication of the PD Request 380, PD Response 385, GO Neg Request 390, GO Neg Response 391, and/or the GO Neg Confirmation 392 of FIG. 3B.

The operations of this embodiment 900 may be employed to carry out the functionality described above with respect to FIGS. 2-8.

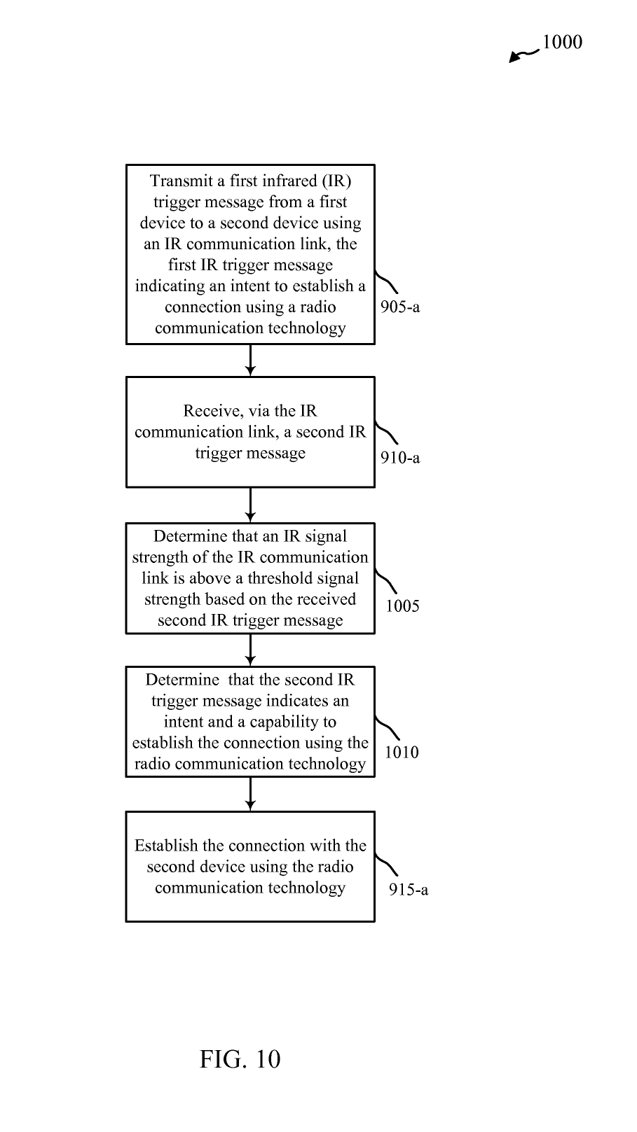

FIG. 10 is a flowchart illustrating yet another embodiment of a method 1000 of establishing an IR triggered WLAN link. At block 905-a, a first device, such as device 110, 400, 500, 600, or 700, as described above, may transmit a first IR trigger message to a second device or AP using an IR communication link, where the first IR trigger message indicates an intent to establish a connection using a radio communication technology (e.g., Wi-Fi, Wi-Fi Direct, Wi-Fi P2P, etc.).

At block 910-a, the first device may receive, via the IR communication link, a second IR trigger message. The second IR trigger message may, for example, match the first IR trigger message or may indicate an ability of the second device or AP to form an IR-triggered WLAN connection. The first and second IR trigger messages may examples of messages 325, 330 of FIGS. 3A or 3B.

At block 1005, the first device may determine that an IR signal strength of the IR communication link is above a threshold signal strength based on the received second IR trigger message.

Then, at block 1010, the first device may determine that the second IR trigger message indicates an intent and a capability to establish the connection using the radio communication technology. In some embodiments, the second trigger message may include a predetermined IR code. When the first device receives the second IR trigger message, it may then determine, based on the IR code, that the second device has the intent and capability to form a WLAN link.

Finally, at block 915-a, the first device may establish the connection with the second device using the radio communication technology.

The operations of this embodiment 1000 may particularly be employed to carry out the functionality described above with respect to FIGS. 2-8.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi, Wi-Fi P2P, Wi-Fi Direct, etc.), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes a WLAN system for purposes of example, and WLAN terminology is used in much of the description above, although the techniques are applicable beyond WLAN applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks, components, and modules described in connection with the disclosure herein may be implemented or performed with an at least one general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method, comprising:
transmitting a first infrared (IR) trigger message from a first device to a second device using an IR communication link, the first IR trigger message indicating an intent to establish a connection using a radio communication technology;
receiving, via the IR communication link, a second IR trigger message; and
in response to receiving the second IR trigger message, establishing the connection with the second device using the radio communication technology.

2. The method of claim 1, further comprising:
determining that an IR signal strength of the IR communication link is above a threshold signal strength based on the received second IR trigger message; and
determining that the second IR trigger message indicates the intent and a capability to establish the connection using the radio communication technology.

3. The method of claim 1, wherein establishing the connection comprises:
transmitting, by the first device, a scan request using the radio communication technology; and
receiving, by the first device, a scan response from the second device using the radio communication technology.

4. The method of claim 1, wherein establishing the connection further comprises:
determining a P2P initiator device by comparing a MAC address of the first device and a MAC address of the second device; and
transmitting, if the first device is the P2P initiator device, a provisional discovery (PD) request to initialize a P2P group with the second device.

5. The method of claim 4, further comprising:
exchanging the MAC addresses of the first device and the second device for determining the P2P initiator device via the IR communication link.

6. The method of claim 1, wherein establishing the connection with the second device further comprises exchanging connection information associated with the radio communication technology with the second device over the IR communication link, wherein the connection information comprises one or more of a P2P IE intent value, a listening channel ID, or an operating channel ID.

7. The method of claim 1, wherein establishing the connection comprises transmitting connection information to a third device to allow the third device to establish the connection with the second device using the radio communication technology.

8. The method of claim 1, wherein the radio communication technology comprises one from a group consisting of Wi-Fi and Wi-Fi-Direct.

9. The method of claim 1, wherein the connection is a peer to peer (P2P) connection.

10. The method of claim 1, wherein one of the first device and the second device is one from a group consisting of a mobile device, a printer, a projector, an display, a photo frame, and a set-top box.

11. The method claim 10, wherein the other of the first device or the second device is a mobile device.

12. A computer program product comprising a non-transitory computer-readable medium storing instructions executable by a processor to:
transmit a first infrared (IR) trigger message to a second device using an IR communication link, the first IR trigger message indicating an intent to establish a connection using a radio communication technology;
receive, via the IR communication link, a second IR trigger message; and
in response to receiving the second IR trigger message, establish the connection with the second device using the radio communication technology.

13. The computer program product of claim 12, wherein the instructions are executable by the processor to:
determine that an IR signal strength of the IR communication link is above a threshold signal strength based on the received second IR trigger message; and
determine that the second IR trigger message indicates the intent and a capability to establish the connection using the radio communication technology.

14. The computer program product of claim 12, wherein the instructions executable by the processor to establish the connection further comprise instructions to:
transmit a scan request using the radio communication technology; and
receive a scan response from the second device using the radio communication technology.

15. The computer program product of claim 12, wherein the instructions executable by the processor to establish the connection further comprise instructions to:
determine a P2P initiator device by comparing a MAC address of the wireless communications device and a MAC address of the second device; and
transmit, if the wireless communications device is the P2P initiator device, a provisional discovery (PD) request to initialize a P2P group with the second device.

16. A wireless communications device, comprising:
an infrared (IR) communication port to:
transmit a first infrared (IR) trigger message to a second device over an IR communication link, the first IR trigger message indicating an intent to establish a connection using a radio interface of the wireless communications device, and
receive, via the IR communication link, a second IR trigger message; and
a radio interface communicably coupled to the IR communication port and to, in response to the IR communication port receiving the second IR trigger message, establish the connection with the second device.

17. The wireless communications device of claim 16, the IR communication port to:
determine that an IR signal strength of the IR communication link is above a threshold signal strength based on the received second IR trigger message; and
determine that the second IR trigger message indicates the intent and a capability to establish the connection using the radio communication technology.

18. The wireless communications device of claim 16, the radio interface to:
transmit a scan request using the radio communication technology; and
receive a scan response from the second device using the radio communication technology.

19. The wireless communications device of claim 16, the IR communication port to transmit and receive connection information associated with the radio communication technology with the second device over the IR communication link, wherein the connection information comprises one or more of a P2P IE intent value, a listening channel ID, or an operating channel ID.

20. The wireless communications device of claim 16, the radio interface to transmit connection information to a third device to allow the third device to establish the connection with the second device using the radio communication technology.
